(19) United States
(12) Patent Application Publication
(10) Pub. No.: US 2003/0061613 A1
(43) Pub. Date: Mar. 27, 2003

(54) Information processor

(76) Inventor: Kenji Inose, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/182,944

(22) PCT Filed: Dec. 14, 2001
(86) PCT No.: PCT/JP01/10975

(30) Foreign Application Priority Data
Dec. 14, 2000 (JP) 2000-379731

(51) Int. Cl. H04H 1/00; H04N 7/20

(52) U.S. Cl. 725/68; 455/3.02

(57) ABSTRACT

The present invention relates to an information processing device that can transfer and set a condition in front end processing according to the procedure based on the rule of I²C or transfer the condition in the form of a command set. An application 31B generates control data to be transferred to a front end, and supplies the control data to an interface 31C through OS 31A together with information indicating a transfer pattern (first transfer pattern (a pattern in which the control data are transferred according to the procedure based on the rule of I²C) or a second transfer pattern (a pattern in which the control data are transferred in the form of a command set)). An interface 31C stores the control data in a transfer format by a storage method based on the transfer pattern indicated by the information, and transfers the control data to a microcomputer of the front end. The present invention is applicable to IRD.

### BACKGROUND OF THE INVENTION

1. Field of the Invention

The present invention relates to an information processing device, and particularly to an information processing device which is suitably used to receive broadcast waves distributed through a broadcast satellite in a digital satellite broadcast system (transmission media).

2. Description of the Related Art

There has been recently proposed a digital satellite broadcast system in which several hundreds of programs are distributed through a broadcast satellite to audience by using carrier wave frequencies allocated to the channels for the programs.

In a device such as IRD (Integrated Reception device/Decoder) for receiving each carrier wave frequency in the digital satellite broadcast system, a receiving/demodulating unit equipped in the device receives each carrier wave frequency (satellite broadcast wave) distributed through the broadcast satellite, selects a prescribed carrier wave frequency from the carrier wave frequencies thus received and then demodulate the prescribed carrier wave frequency to achieve a transport stream.

FIG. 1 shows the information reception/transmission relationship between CPU 1 and a front end 2 in IRD.

The front end 2 serving as the reception/modulation device comprises a tuner portion 11-1 for selecting a desired frequency, a demodulating portion 11-2 for demodulating a modulation signal and a correcting portion 11-3 for correcting errors occurring during transmission, and it is controlled by CPU 1.

CPU 1 is designed to execute various kinds of processing according to programs read out from a prescribed memory (not shown), and it is functionally equipped with an operating system (herein after referred to as “OS”) 1A, an application program 1B and a driver 1C.

Here, when a user selects a channel for a desired program through an input portion (not shown) equipped to IRD, the application program 1B of CPU 1 identifies the carrier wave frequency to which the user's desired program is allocated, and transfers the identification result (information to inform the user what carrier wave frequency (Hz) is allocated to the user's desired channel to the driver 1C.

The driver 1C carries out the data processing on the basis of the identification result transmitted from the application program 1B so that the respective parts (the tuner portion 11-1, the demodulating portion 11-2 and the error correcting portion 11-3) of the front end 2 can operate, whereby the front end 2 is set to such a state that the front end 2 can execute the processing of selecting the carrier wave frequency as the identification result of the application program 1B from the satellite broadcast wave received through the broadcast satellite and then outputting the carrier wave frequency thus selected to the outside as a transport stream (hereinafter referred to as “front end processing”) (accurately, various conditions in the front end processing such as the carrier wave frequency selected by the user, a prescribed demodulation method, etc. are set).

Accordingly, the tuner portion 11-1 searches the satellite broadcast waves received through the broadcast satellite with a prescribed resolution (hereinafter referred to as “resolution for search”), selects a set carrier wave frequency from the satellite broadcast waves thus received, conducts predetermined frequency conversion on the carrier wave frequency thus selected to generate an intermediate frequency and then transmits the intermediate frequency to the demodulating portion 11-2.

The demodulating portion 11-2 carries out predetermined demodulation processing on the intermediate frequency supplied from the tuner portion 11-1 and then transmits the processing result (the intermediate frequency thus demodulated) to the error correcting portion 11-3. The error correcting portion 11-3 conducts predetermined error correction processing on a transport stream by using a data sequence for error detection or the like which is allocated in advance, and outputs the transport stream thus achieved to the outside of the front end 2.

The setting of a condition in the front end processing is carried out through transfer of the content of the condition from the driver 1C of CPU 1 to the front end 2 according to the procedure based on the rule of a communication protocol called as “I²C”. In the following description, this transfer will be referred to as “transfer based on first transfer pattern” at pleasure.

For example, the setting of the carrier wave frequency (the carrier wave frequency allocated to a channel selected by the user) is carried out by converting the carrier wave frequency to a value which is conformed with the resolution for search (hereinafter referred to as “carrier wave frequency setting data”) and then transferring the carrier wave frequency setting data to the front end 2 according to the procedure based on the rule of I²C (the procedure for setting the carrier wave frequency).

The front end 2 which receives the data thus transferred understands on the basis of the transfer procedure that the data thus transferred are the carrier wave frequency setting data, deciphers the carrier wave frequency and the resolution for search on the basis of the carrier wave frequency setting data and then executes the front end processing on the basis of the decipher result.

As described above, when the carrier wave frequency is set, the resolution for search can be set to any value because it can be changed within some range. That is, the condition of the front end processing can be set minutely.

However, since the transfer procedure is determined in conformity with the specification of the front end 2 (for example, performance and function), when it is needed to alter the tuner portion 11-1, the demodulating portion 11-2 and the error correcting portion 11-3 of the front end 2 (hereinafter referred to as “hardware 11” when they are not needed to be discriminated from each other), the driver 1C of CPU 1 must be changed in accordance with the alteration of the hardware 11 (the program must be changed). Therefore, there may be considered a method in which various conditions in the front end processing are set for the front end 2 by transferring a command set pre-defined between CPU 1 and the front end 2 (accurately, a command which is defined in advance between a programmer of CPU 1 and a manufacturer of the front end 2) to the front end 2. In the following description, this transfer will be referred to as “transfer based on second transfer pattern” at pleasure.

In the case of the transfer based on the second transfer pattern, if a front end manufactured by a manufacturer of the same type of front ends 2 (a front end which can understand a pre-defined command) is used, it is unnecessary to change the program of CPU 1 even when the front end 2 is replaced by another.

In this case, however, there is a problem that it is impossible to set more minute conditions as compared with the case where the condition content is transferred according to the procedure based on the rule of I²C.

For example, the setting of the carrier wave frequency (the carrier wave frequency allocated to a channel selected by the user) is performed by the transfer of a command set for instructing the setting of the carrier wave frequency and the carrier wave frequency itself from CPU 1 to the front end 2. The front end 2 receiving the command set and the carrier wave frequency understands on the basis of the command that the data thus transferred is the carrier wave frequency, and executes the front end processing of selecting the carrier wave frequency with a predetermined resolution for search.

As described above, the resolution for search is determined in the front end 2, and thus it cannot be freely changed unlike the case where the condition content is transferred according to the procedure based on the rule of I²C.

### SUMMARY OF THE INVENTION

The present invention has been implemented in view of the foregoing situation, and has an object to enable conditions in front end processing to be transferred and set according to the procedure based on the rule of I²C or in the form of a command set.

In order to achieve the object, there is provided an information processing device characterized by comprising: generating means for generating control data; determining means for determining whether the control data should be transferred by using a first transfer pattern which is conformed with a procedure determined on the basis of the specification of a reception device or by using a second transfer pattern using commands defined between the reception device and the data transfer source (information processing device) itself; first transfer means for transferring the control data generated by the generating means to the reception device by using the first transfer pattern when it is determined by the determining means that the control data are transferred by using the first transfer pattern; and second transfer means for transferring the control data generated by the generating means to the reception device by using the second transfer pattern when it is determined by the determining means that the control data are transferred by using the second transfer pattern.

In order to achieve the object, there is provided an information processing method characterized by comprising: a generating step of generating control data; a determining step of determining whether the control data should be transferred by using a first transfer pattern which is conformed with a procedure determined on the basis of the specification of a reception device or by using a second transfer pattern using commands defined between the reception device and a data transfer source (information processing device) itself; a first transfer step of transferring the control data generated in the generating step to the reception device by using the first transfer pattern when it is determined in the determining step that the control data are transferred by using the first transfer pattern; and a second transfer step of transferring the control data generated in the generating step to the reception device by using the second-transfer pattern when it is determined in the determining step that the control data are transferred by using the second transfer pattern.

In order to achieve the object, there is provided a program of a first recording medium characterized by containing: a generating step of generating control data; a determining step of determining whether the control data should be transferred by using a first transfer pattern which is conformed with a procedure determined on the basis of the specification of a reception device or by using a second transfer pattern using commands defined between the reception device and a data transfer source (information processing device) itself; a first transfer step of transferring the control data generated in the generating step to the reception device by using the first transfer pattern when it is determined in the determining step that the control data are transferred by using the first transfer pattern; and a second transfer step of transferring the control data generated in the generating step to the reception device by using the second transfer pattern when it is determined in the determining step that the control data are transferred by using the second transfer pattern.

In the information processing device and method of the present invention and the program of the first recording medium of the present invention, the control data are generated, and it is determined whether the control data should be transferred by using the first transfer pattern which is conformed with the procedure determined on the basis of the specification of the reception device or by using the second transfer pattern using commands defined between the reception device and the data transfer source (information processing device) itself. Further, when it is determined that the control data are transferred by using the first transfer pattern, the control data thus generated are transferred to the reception device by using the first transfer pattern, and when it is determined that the control data are transferred by using the second transfer pattern, the control data thus generated are transferred to the reception device by using the second transfer pattern.

In order to attain the above object, there is provided a reception device characterized by comprising: reception means for receiving control data which are transferred from a controller by using a first transfer pattern conformed with a procedure determined on the basis of the specification of itself or by a second transfer pattern using commands defined between the controller and the data reception target (reception device); judging means for judging whether the control data received by the reception means are transferred by using the first transfer pattern or the second transfer pattern; first executing means for interpreting the meaning of the procedure and executing the processing based on the interpretation result on signals transmitted through a transfer medium when it is judged by the judging means that the control data are transferred by using the first transfer pattern; and second executing means for interpreting the meaning of the procedure and executing the processing based on the interpretation result on signals transmitted through a transfer medium when it is judged by the judging means that the control data are transferred by using the second transfer pattern.

In order to attain the above object, there is provided a reception method characterized by comprising: a reception step of receiving control data which are transferred from a controller by using a first transfer pattern conformed with a procedure determined on the basis of the specification of itself or by a second transfer pattern using commands defined between the controller and the data reception target (reception device); a judging step of judging whether the control data received in the processing of the reception step are transferred by using the first transfer pattern or the second transfer pattern; a first executing step of interpreting the meaning of the procedure and executing the processing based on the interpretation result on signals transmitted through a transfer medium when it is judged in the processing of the judging step that the control data are transferred by using the first transfer pattern; and a second executing step of interpreting the meaning of the procedure and executing the processing based on the interpretation result on signals transmitted through a transfer medium when it is judged in the processing of the judging means that the control data are transferred by using the second transfer pattern.

In order to attain the above object, there is provided a program of a second recording medium characterized by containing: a reception step of receiving control data which are transferred from a controller by using a first transfer pattern conformed with a procedure determined on the basis of the specification of itself or by a second transfer pattern using commands defined between the controller and the data reception target (reception device); a judging step of judging whether the control data received in the processing of the reception step are transferred by using the first transfer pattern or the second transfer pattern; a first executing step of interpreting the meaning of the procedure and executing the processing based on the interpretation result on signals transmitted through a transfer medium when it is judged in the processing of the judging step that the control data are transferred by using the first transfer pattern; and a second executing step of interpreting the meaning of the procedure and executing the processing based on the interpretation result on signals transmitted through a transfer medium when it is judged in the processing of the judging means that the control data-are transferred by using the second transfer pattern.

In the reception device and method of the present invention and the program of the second recording medium of the present invention, the control data which are transferred from the controller by using the first transfer pattern conformed with the procedure determined on the basis of the specification of itself or by the second transfer pattern using commands defined between the controller and the data reception target (reception device) are received, it is judged whether the control data received are transferred by using the first transfer pattern or the second transfer pattern, the meaning of the procedure is interpreted and the processing based on the interpretation result is executed on signals transmitted through a transfer medium when it is judged that the control data are transferred by using the first transfer pattern; and the meaning of the procedure is interpreted and the processing based on the interpretation result is executed on signals transmitted through a transfer medium when it is judged that the control data are transferred by using the second transfer pattern.

### BRIEF DESCRIPTION OF THE DRAWINGS

FIG. 1 is a diagram showing conventional IRD;

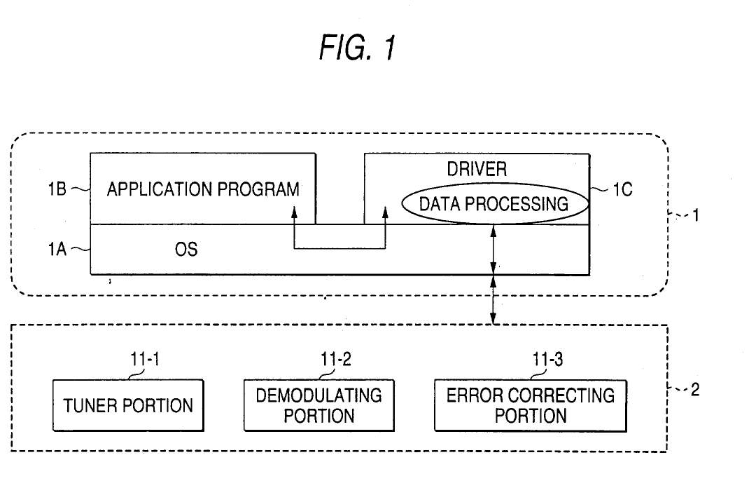

FIG. 2 is a diagram showing the construction of a digital broadcast reception system to which the present invention is applied;

FIG. 3 is a block diagram showing the construction of IRD of FIG. 2;

FIG. 4 is a block diagram showing the construction on hardware of a front end of FIG. 3 and showing the functional construction of CPU and a microcomputer;

FIG. 5 is a diagram showing a transfer format of control data;

FIG. 6 is a diagram showing data stored in a transfer format;

FIG. 7 is a diagram showing binary data of 62000;

FIG. 8 is a diagram showing addresses of a register;

FIG. 9 is a diagram showing ID of commands;

FIG. 10 is a flowchart showing the operation of CPU of FIG. 3; and

FIG. 11 is a flowchart showing the operation of a front end of FIG. 3.

### DETAILED DESCRIPTION OF THE PREFERRED EMBODIMENTS

Preferred embodiments according to the present invention will be described hereunder with reference to the accompanying drawings.

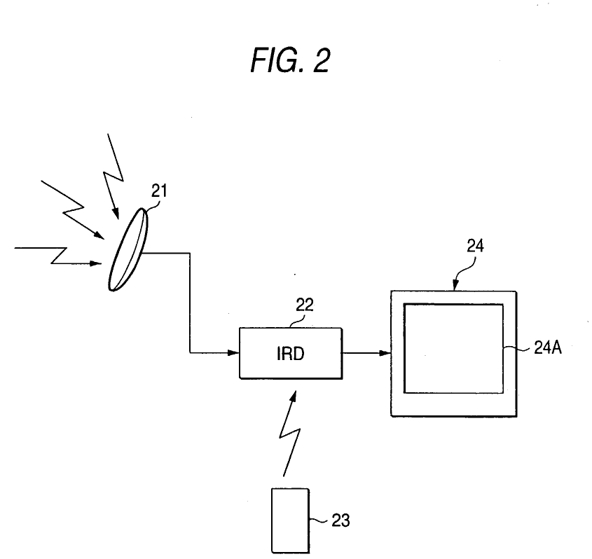

FIG. 2 is a diagram showing the construction of a digital broadcast receiving system.

IRD 22 receives satellite broadcast waves distributed through a broadcast satellite (not shown) by using a parabola antenna 21.

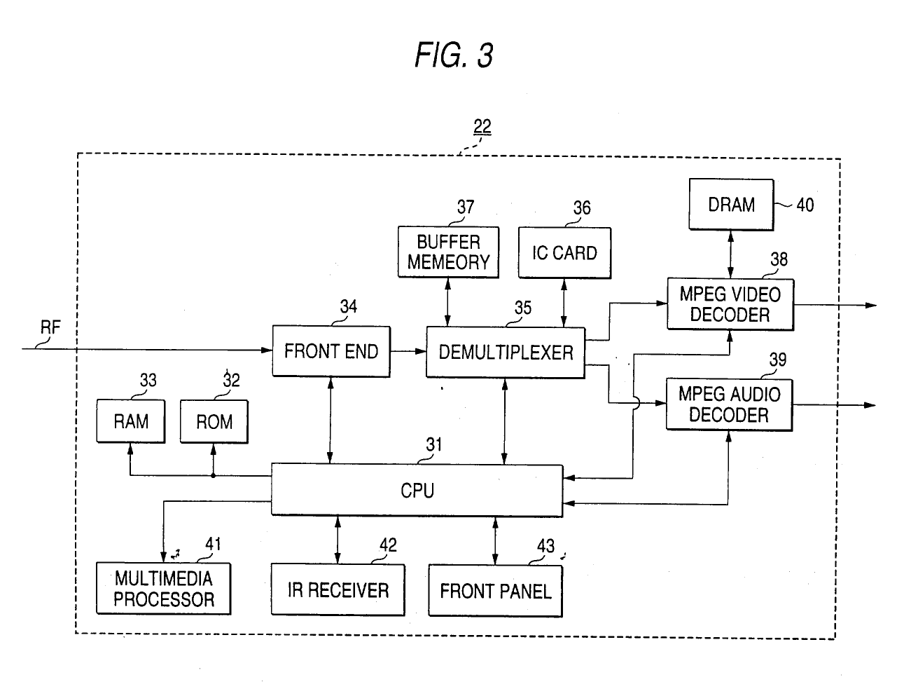

When a prescribed channel is indicated by user's operation of a remote controller 23 or front panel 43 (see FIG. 3), the carrier wave frequency allocated to the channel concerned is selected from the satellite broadcast waves thus received. Thereafter, IRD 22 outputs to a television set 24 prescribed data such as video data, audio data, program guide information (hereinafter referred to as “EPG (Electronic Program Guide)”, etc. which are achieved on the basis of the carrier wave frequency thus selected.

The television set 24 visually displays pictures achieved on the basis of the prescribed data supplied from IRD 22, together with the content of EPG if necessary, on a monitor 24A such as CRT (Cathode Ray Tube), a liquid crystal display or the like, and also outputs sounds from a speaker(s) (not shown).

FIG. 3 shows the internal construction of IRD 22.

When an instruction of starting IRD 22 is input from an IR reception device 42 or the front panel 43 to CPU 31, CPU 31 develops an operating system (OS) 31A stored in ROM 32, so that CPU 31 is allowed to execute various kinds of processing.

When a prescribed instruction is input from the IR reception device 42 or the front end panel 43 to CPU 31, CPU 31 also develops the program corresponding to the instruction on RAM 33 (OS 31A) to control the respective parts. For example, CPU 31 sets a condition for the front end processing in the front end 34 by developing an application program 31B and an interface 31C on OS 31A, and makes the front end 34 execute the front end processing based on the condition thus set (the processing of selecting a prescribed carrier wave frequency from the satellite broadcast waves received and supplying it as a transport stream to a demultiplexer 35).

CPU 31 transfers the condition content in the front end processing (hereinafter referred to as “control data”) to the front end 34 according the processing procedure based on the rule of I²C condition (by using a first transfer pattern) or in the form of a command set (by using a second transfer pattern, whereby the condition setting in the front end processing is carried out.

The demultiplexer 35 reads out key information stored in an IC card 36 as occasion demands, deciphers an enciphered transport stream supplied from the front end 34 and temporarily stores the transport stream thus deciphered in a buffer memory 37 comprising DRAM (Dynamic Random Access Memory) or SRAM (Static Random Access Memory).

Since digital broadcast (transport stream) distributed through a broadcast satellite (not shown) is enciphered, it is necessary to decipher the enciphered digital broadcast in order to watch/listen to the digital broadcast.

The demultiplexer 35 also reads out a transport stream stored temporarily in the buffer memory 37, and transmits to an MPEG video decoder 38 MPEG video data which are achieved by decomposing the transport stream thus read out. In addition, the demultiplexer 35 outputs MPEG audio data to an MPEG audio decoder 39.

The demultiplexer 35 further receives EPG data supplied from the front end 34 (data which are temporarily stored in the buffer memory 37), and transmits the data through CPU 31 to a multimedia processor 41.

The MPEG video decoder 38 subjects the MPEG video data supplied from the demultiplexer 35 to the decode processing based on the MPEG 2 system to thereby restore the MPEG video data to the original video data, and then output the original video data to the television set 24 (FIG. 2).

The MPEG video decoder 38 reads out EPG data (program guide information) written in a bit-map format in DRAM 40, and outputs the EPG data to the television set 24.

The MPEG audio decoder 39 subjects the MPEG audio data supplied from the demultiplexer 35 to the decode processing based on the MPEG2 system to thereby restore the MPEG audio data to the original audio data, and then outputs the original audio data to the television set 24.

The multimedia processor 41 generates EPG data to display a program table, a program guide, etc. The EPG data thus generated are written in DRAM 40. The program guide information is frequently transmitted, and thus the latest EPG data are held in a memory (not shown) of the multimedia processor 41 at all times.

The IR reception device 42 detects an infrared-ray signal on which the content of an operation applied to the remote controller 23 is superposed, and supplies the photodetection result to CPU 31.

The front panel 43 is operated by a user as occasion demands when a prescribed instruction is input to CPU 31.

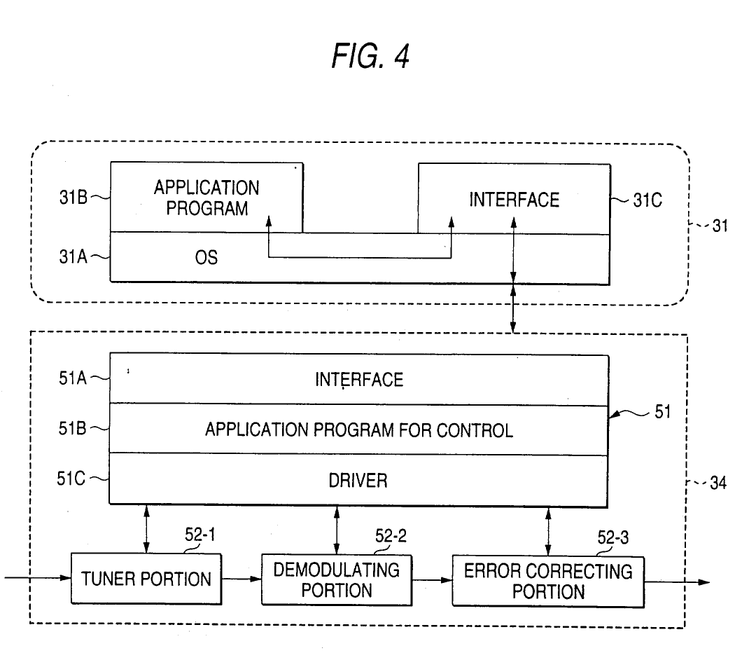

Next, the on-hardware construction of the front end 34 and the functional construction of CPU 31 and a microcomputer 51 of the front end 34 will be described with reference to FIG. 4.

The front end 34 comprises, on hardware, a microcomputer 51, a tuner portion 52-1, a demodulating portion 52-2 and an error correcting portion 52-3 (hereinafter collectively referred to as “hardware 52” when it is unnecessary to discriminate these parts from one another).

The microcomputer 51 communicates with CPU 31 and controls the hardware 52 on the basis of the communication result.

The satellite broadcast waves received by the parabola antenna 21 are input to the tuner portion 52-1 of the hardware 52. In response to the instruction from the microcomputer 51, the tuner portion 52-1 selects a carrier wave frequency allocated to a desired channel (the channel indicated by the user) from the satellite broadcast waves thus input. The tuner portion 52-1 conducts predetermined frequency conversion on the carrier wave frequency thus selected to generate an intermediate frequency, and outputs the intermediate frequency thus generated to the demodulating portion 52-2.

The demodulating portion 52-2 carries outs predetermined demodulation processing on the intermediate frequency supplied from the tuner portion 52-1, and then transmits the intermediate frequency thus demodulated to the error correcting portion 52-3. The error correcting portion 52-3 carries out predetermined error correction processing on a transport stream by using a data sequence which is allocated for error detection or the like in advance, and outputs the transport stream thus achieved to the demultiplexer 35.

Next, the functional construction of CPU 31 and the microcomputer 51 of the front end 34 will be described.

CPU 31 has an application program 31B and an interface 31C.

The application program 31B generates control data to be transferred to the front end 34, and supplies the control data through OS 31A to the interface 31C together with information indicating a transfer pattern (a first transfer pattern (a transfer pattern for transferring the control data according to the procedure based on the rule of I²C) or a second transfer pattern (a transfer pattern for transferring the control data as a command set)).

The interface 31C communicates with the microcomputer 51 of the front end 34. For example, the interface 31C stores the control data in a prescribed format (hereinafter referred to as “transfer format”) by using a method based on the transfer pattern indicated by the transfer-pattern indicating information supplied from the application program 31B, and then transfers the control data to the microcomputer 51 (interface 51A) of the front end 34.

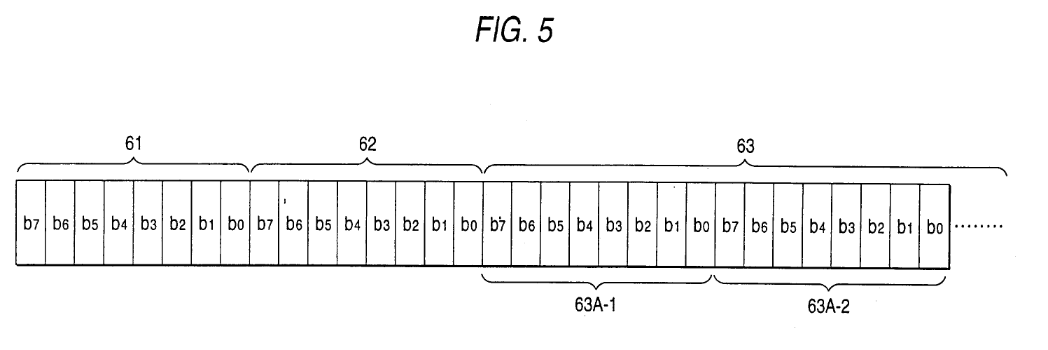

FIG. 5 shows the construction of the transfer format.

The transfer format comprises an IC address portion 61, a register address portion 62 and a data portion 63.

In any case of the first transfer pattern and the second transfer pattern, the control data are stored in the transfer format and then transferred. The storage method of the control data is varied in accordance with the kind of the transfer pattern.

Next, the storage method when the control data are transferred by using the first transfer pattern will be described.

In this case, the address of the hardware 52 of the front end 34 to be controlled (the tuner portion 52-1, the demodulating portion 52-2 or the error correcting portion 52-3) as 1-byte data in the IC address portion 61. Further, the address of the register in the hardware 52 whose address is stored in the IC address portion 61 is stored as 1-byte data in the register address portion 62. Still further, data to be written in the register of the hardware 52 whose address is stored in the register address portion 62 are stored in the register address portion 62. The data portion 63 has data portions 63A whose number corresponds to the amount of the data to be stored in the data portion 63, 1-byte data being stored in each of the data portions 63A.

Next, a case that a carrier wave frequency (1458 MHz) allocated to a channel A (channel indicated by the user) is set to the front end 34 for data to be stored in the IC address portion 61, the register address portion 62 and the data portion 63 when the control data are transferred by the first transfer pattern will be described again.

The address of the tuner portion 52-1 is stored in the IC address portion 61. The address of the register in the tuner portion 52-1 is originally stored in the register address portion 62. However, in this case, the tuner portion 52-1 has no register, and thus the register address portion 62 is deleted.

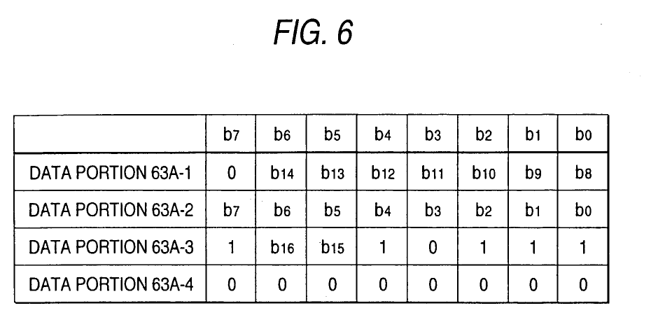

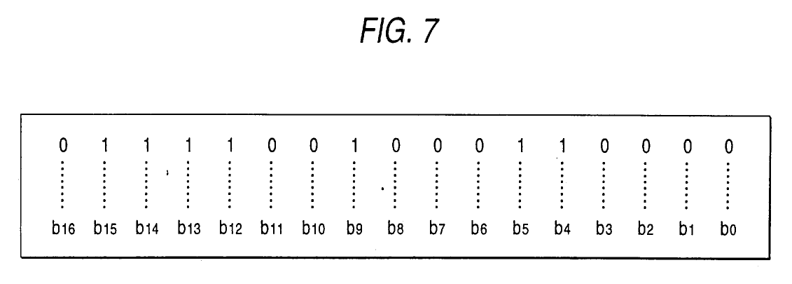

In this case, the data portion 63 has four data portions 63A-1 to 63A-4 as shown in FIG. 6, and the binary data (17 bits of b₀ to b₁₆) (FIG. 7) of the carrier wave frequency setting data (62000) calculated by substituting 1458 MHz as the carrier wave frequency into the following equation (1) are stored in the data portions 63A-1 to 63A-4 according to the rule of I²C.

Carrier wave frequency setting data=(carrier wave frequency MHz+479.5 MHz)/31.25 KHz (1)

Specifically, as shown in FIG. 6, the carrier wave frequency setting data (b₈ to b₁₆) are stored in the data portions 63A-1 (b₀ to b₁₆), the carrier wave frequency setting data (b₀ to b₇) are stored in the data portion 63A-2 (b₀ to b₇), and the carrier wave frequency setting data (b₅, b₆) are stored in the data storage portion 63A-3 (b₅, b₆). Further, according to a prescribed rule, “0” or “1” is stored in portions of the data portions 63A-1 to 63A-4 in which no carrier wave frequency setting data are stored as shown in FIG. 6.

31.25 KHz in the equation (1) represents the resolution for search, and 479.5 MHz represents the frequency inherent to the tuner portion 52-1.

When the control data are transferred by using the first transfer data, the control data are stored in the transfer format as described above.

Next, the storage method when the control data are transferred by using the second transfer pattern will be described.

As in the case of the transfer based on the first transfer pattern, the address of the hardware 52 of the front end 34 to be controlled is stored in the IC address portion 61. A specific address (hereinafter referred to as “special address”) (in this case, “11111”) is stored in the register address portion 62.

In the data portion 63A-1 of the data portion 63 is stored ID of a command indicating the content of an instruction to the hardware 52 whose address is stored in the IC address portion 61. In the data portion 63A-2 and the subsequent data portions 63A are stored data which are required so that the hardware 52 whose address is stored in the IC register portion 61 executes the processing based on the command whose ID is stored in the data portion 63A-1.

Next, a case that the carrier wave frequency (1458 MHz) allocated to the channel A (the channel indicated by the user) is set to the front end 34 for data to be stored in the IC address portion 61, the register address portion 62 and the data portion 63 when the control data are transferred by the second transfer pattern will be described again.

The address of the tuner portion 52-1 is stored in the IC address portion 61. The special address (“11111”) is stored as 1-byte data in the register address portion 62. Further, ID of a command for instructing the setting of the carrier wave frequency (in this case, 0x01) is stored in the data portion 63A-1 of the data portion 63, and 1458 MHz of the carrier wave frequency is stored in the form of binary data in the data portion 63A-2 and the subsequent the data portions 63A.

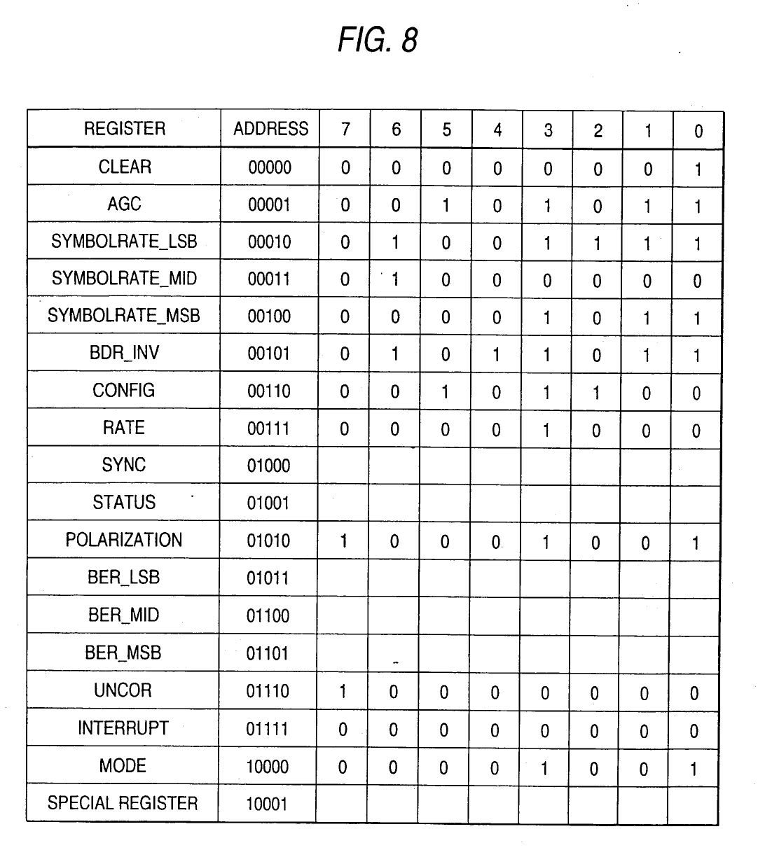

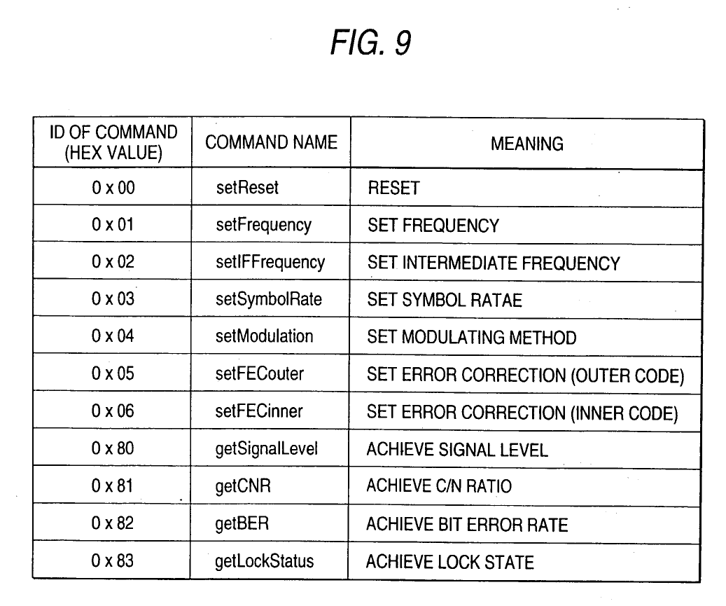

The address of the hardware 52, the address of the register in the hardware 52, the special address and ID of the command are stored in ROM 32 (FIG. 3). FIG. 8 shows an example of the addresses of the register in the hardware 52 and the address of the special register, and FIG. 9 shows an example of IDs of commands.

When the control data are transferred in the form of the second transfer data, the control data are stored in the transfer format as described above.

Returning to FIG. 4, the microcomputer 51 of the front end 34 functionally has an interface 51A, an application program 51B for control and a driver 51C.

The interface 51A communicates with the interface 31C of CPU 31. For example, the interface 51A receives the control data transferred from the interface 31C by using the first transfer pattern or the second transfer pattern, and supplies the control data thus received to the control application program 51B.

The control application program 51B judges whether the control data supplied from the interface 51A are transferred by using the first transfer pattern or the second transfer pattern, recognizes the content of the control data in accordance with the judgment result and then supplies the recognition result to the driver 51C.

The driver 51C converts the recognition result supplied from the control application program 51B to data which can be understood by the hardware 52 (the tuner portion 52-1, the demodulating portion 52-2 and the error correcting portion 52-3), and then supplies the data thus converted to the hardware 52. The hardware 52 executes the processing based on the data supplied from the driver 51C.

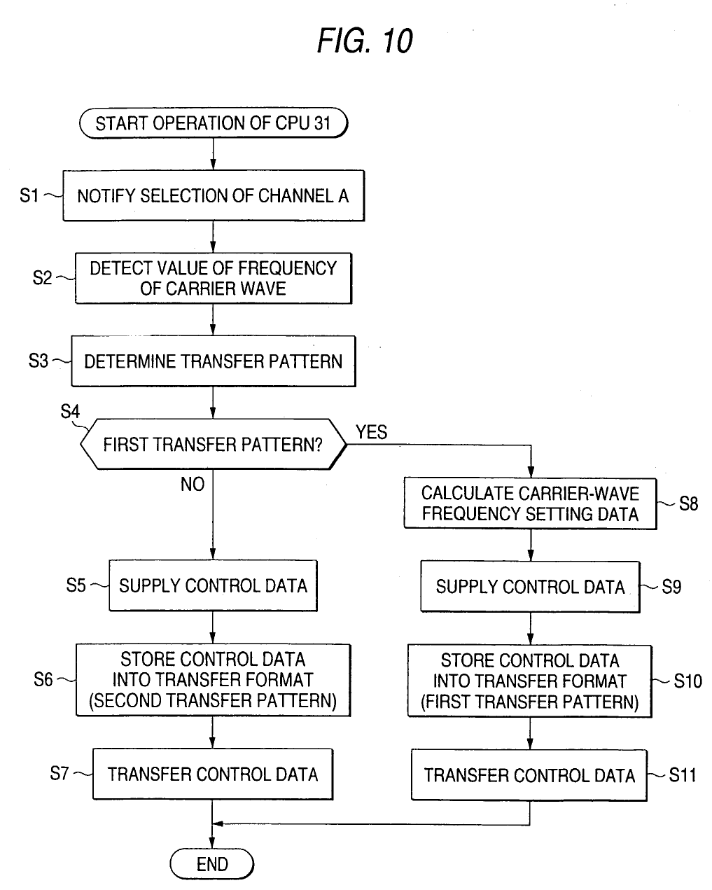

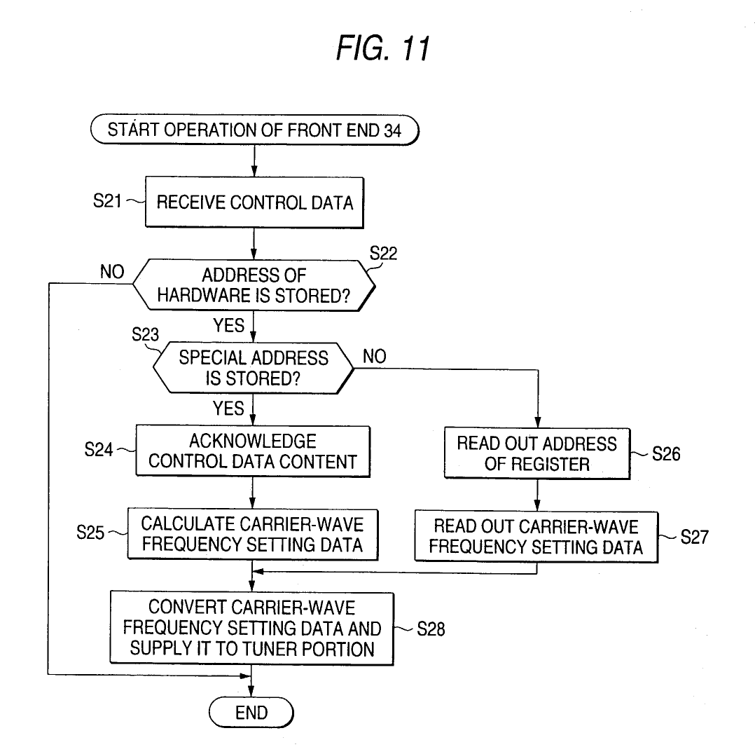

Next, the operation of each of CPU 31 and the front end 34 when the front end 34 is controlled will be described with reference to the flowcharts of FIGS. 10 and 11. In this case, it is assumed that CPU 31 makes the front end 34 output the channel A (the channel to which the carrier wave frequency of 1458 MHz is allocated) as a transport stream to the demultiplexer 35.

First, the operation of CPU 31 will be described with reference to the flowchart of FIG. 10.

In step S1, OS 31A of CPU 31 notifies it to the application program 31B that the remote controller 23 or the front panel 43 is operated by the user and the channel A is selected. Subsequently, in step S2, the application program 31B detects the carrier wave frequency (1458 MHz) to which the channel A notified in step S1 is allocated.

In step S3, the application program 31B determines the transfer pattern of the control data. In this case, in cases other than a normal case that IRD 22 is normally used, for example, a case where the reception state of electric waves is adjusted or the like, the control data are transferred by using the first transfer pattern. However, in the normal case, the control data are transferred by using the second transfer pattern. That is, the application program 31B judges whether, for example, an indication of starting the adjustment of IRD 22 is notified from OS 31A or not (that is, the normal use of IRD 22 or not), and determines the transfer pattern of the control data on the basis of the judgment result.

Subsequently, in step S4, the application program 31B judges whether the transfer pattern determined in step S3 is the first transfer pattern or not, and it goes to step S5 if the transfer pattern is not the first transfer pattern. That is, in the step S5 and the subsequent steps, the processing of transferring the control data by the second transfer pattern is carried out.

In step S5, the application program 31B transfers the carrier wave frequency (1458 MHz) detected in step S2 as the control data by the second transfer pattern, and also supplies the control data to the interface 31C.

Subsequently, in step S6, the interface 31C stores the control data from the application program 31B into the transfer format by the storage method for the transfer based on the second transfer pattern. That is-, the special register (“11111”) is stored in the register address portion 62. Further, ID (0x01) of a command for instructing the setting the carrier wave frequency is set in the data portion 63A-1 of the data portion 63, and the carrier wave frequency (1458 MHz) is stored in the form of binary data in the data portion 63A-2 and the subsequent data portions 63A.

In step S7, the interface 31C transfers the control data stored in the transfer format in step S6 to the front end 34.

On the other hand, if it is judged in step S4 that the transfer pattern determined in step S3 is the first transfer pattern (for example, when IRD 22 is not normally used), the process goes to step S8, and the application program substitutes the carrier wave frequency (1458 MHz) detected in step S2 into the equation (1) to calculate the carrier wave frequency setting data (62000).

Subsequently, in step S9, the application program 31B transfers the carrier wave frequency setting data (62000) calculated in step S8 as the control data by using the first transfer pattern to the interface 31C together with information indicating the transfer of the control data by the first transfer pattern.

In step S10, the interface 31C stores the control data from the application program 31B into the transfer format by the storage method for the transfer based on the first transfer pattern. That is, the address of the tuner portion 52-1 is stored in the IC address portion 61, the register address portion 62 is omitted. The carrier wave frequency setting data (62000) are stored in the four data portions 63A1- to 63B-4 of the data portion 63 according to the rule shown in FIG. 6.

In step S11, the interface 31 transfers the control data stored in the transfer format in step S10 to the front end 34.

In step S7 or step S1, the control data are transferred to the front end 34, and then the processing is finished.

Next, the operation of the front end 34 will be described with reference to the flowchart of FIG. 11.

In step S21, the interface 51A of the microcomputer 51 of the front end 34 receives the control data (the step S7 or S11 of FIG. 10) transferred from CPU 31 (interface 31C), and supplies the data to the control application program 51B.

In step S22, the control application program 51B judges whether the address of the hardware 52 is stored in the IC address portion 61 of the control data supplied from the interface 51A or not. If it is judged that the address is stored, the process goes step S23. On the other hand, if it is judged that the address is not stored, the processing is finished.

In step S23, the control application program 51B judges whether the special address is stored in the register address portion 62 of the control data or not. If it is judged that the address is stored, the processing goes to step S24.

In step S24, the control application program 51B recognizes it on the basis of ID (0x01) stored in the data portion 63A-1 of the data portion 63 of the control data that the setting of the carrier wave frequency is instructed, and also recognizes it on the basis of the data stored in the data portion 63A-2 and the subsequent data portions 63A that the carrier wave frequency is equal to 1458 MHz.

In step S25, the control application program 51B substitutes 1458 MHz recognized as the carrier wave frequency into the equation (1) to calculate the carrier wave frequency setting data (62000), and supplies the carrier wave frequency setting data thus calculated to the driver 51C.

If it is judged in step S23 that the special address is not stored in the register address portion 62, the processing goes to step S26. In step S26, the control application program 51B reads out the address of the register stored therein, and supplies it to the driver 51C. When the register address portion 62 is omitted like this case, the processing is skipped.

Next, in step S27, the control application program 51B reads out the carrier wave frequency setting data (62000) stored in the data portion 63 of the control data and supplies the data to the driver 51C.

In the process of step S25 or step S27, when the carrier wave frequency setting data (62000) is supplied to the driver 51C, the processing goes to step S28. In step S28, the driver 51C converts the carrier wave frequency setting data (62000) supplied from the control application program 51B into data which can be understood by the tuner portion 52-1, and then supplies the data thus converted to the tuner portion 52-1.

Accordingly, the tuner portion 52-1 selects the carrier wave frequency of 1458 MHz from the satellite broadcast waves with the resolution of 31.25 KHz, and conducts the predetermined frequency conversion on the carrier wave frequency thus selected to generate an intermediate frequency and supply it to the demodulating portion 52-2. The demodulating portion 52-2 carries out the predetermined demodulation processing on the intermediate frequency supplied from the tuner portion 52-1, and transmits the demodulation result to the error correcting portion 52-3. The error correcting portion 52-3 carries out the predetermined error correction procession on the transport stream by using the data sequence which is allocated for error detection or the like in advance, and transmits the transport stream thus achieved to the demultiplexer 35. Thereafter, the processing is finished.

In the above-described embodiment, with respect to the series of processing described above, the programs of CPU 31 or the microcomputer 51 of the front end 34 may be stored in advance in a memory, or temporarily or forever stored (recorded) in a removable recording medium such as a floppy disk, CD-ROM (Compact Disc Read Only Memory), MO (Magneto Optical) disc, DVD (Digital Versatile Disc), a magnetic disc, a semiconductor memory or the like. Such a removable recording medium may be supplied as a so-called packaged software, and it may be installed in IRD.

According to the present invention, the control data can be transferred by each of the first transfer pattern and the second transfer pattern.

What is claimed is:

1. An information processing device for transferring, to a reception device for receiving signals transmitted from a transmission medium, control data for controlling the processing on the signals to be transmitted to the reception device by using a first transfer pattern which is conformed with a procedure determined on the basis of the specification of the reception device or by using a second transfer pattern using commands defined between the reception device and the information processing device itself, characterized by comprising:
generating means for generating control data;
determining means for determining whether the control data should be transferred by using the first transfer pattern or by using the second transfer pattern;
first transfer means for transferring the control data generated by said generating means to the reception device by using the first transfer pattern when it is determined by said determining means that the control data are transferred by using the first transfer pattern; and
second transfer means for transferring the control data generated by said generating means to the reception device by using the second transfer pattern when it is determined by said determining means that the control data are transferred by using the second transfer pattern.

2. An information processing method for an information processing device for transferring, to a reception device for receiving signals transmitted from a transmission medium, control data for controlling the processing on the signals to be transmitted to the reception device by using a first transfer pattern which is conformed with a procedure determined on the basis of the specification of the reception device or by using a second transfer pattern using commands defined between the reception device and the information processing device itself, characterized by comprising:
a generating step of generating control data;
a determining step of determining whether the control data should be transferred by using the first transfer pattern or by using the second transfer pattern;
a first transfer step of transferring the control data generated in said generating step to the reception device by using the first transfer pattern when it is determined in said determining step that the control data are transferred by using the first transfer pattern; and
second transfer step of transferring the control data generated in said generating step to the reception device by using the second transfer pattern when it is determined in said determining step that the control data are transferred by using the second transfer pattern.

3. A program for an information processing method for an information processing device for transferring, to a reception device for receiving signals transmitted from a transmission medium, control data for controlling the processing on the signals to be transmitted to the reception device by using a first transfer pattern which is conformed with a procedure determined on the basis of the specification of the reception device or by using a second transfer pattern using commands defined between the reception device and the information processing device itself, characterized by comprising:
a generating step of generating control data;
a determining step of determining whether the control data should be transferred by using the first transfer pattern or by using the second transfer pattern;
a first transfer step of transferring the control data generated in said generating step to the reception device by using the first transfer pattern when it is determined in said determining step that the control data are transferred by using the first transfer pattern;
and a second transfer step of transferring the control data generated in said generating step to the reception device by using the second transfer pattern when it is determined in said determining step that the control data are transferred by using the second transfer pattern.

4. A reception device characterized by comprising:
reception means for receiving control data which are transferred from a controller by using a first transfer pattern conformed with a procedure determined on the basis of the specification of itself or by a second transfer pattern using commands defined between the controller and said reception device;
judging means for judging whether the control data received by said reception means are transferred by using the first transfer pattern or the second transfer pattern;
first executing means for interpreting the meaning of the procedure and executing the processing based on the interpretation result on signals transmitted through a transfer medium when it is judged by said judging means that the control data are transferred by using the first transfer pattern; and
second executing means for interpreting the meaning of the procedure and executing the processing based on the interpretation result on signals transmitted through a transfer medium when it is judged by said judging means that the control data are transferred by using the second transfer pattern.

5. A reception method characterized by comprising:
a reception step of receiving control data which are transferred from a controller by using a first transfer pattern conformed with a procedure determined on the basis of the specification of itself or by a second transfer pattern using commands defined between the controller and a reception side;
a judging step of judging whether the control data received in the processing of said reception step are transferred by using the first transfer pattern or the second transfer pattern;
a first executing step of interpreting the meaning of the procedure and executing the processing based on the interpretation result on signals transmitted through a transfer medium when it is judged in the processing of said judging step that the control data are transferred by using the first transfer pattern; and
a second executing step of interpreting the meaning of the procedure and executing the processing based on the interpretation result on signals transmitted through a transfer medium when it is judged in the processing of said judging means that the control data are transferred by using the second transfer pattern.

6. A recording medium in which a computer-readable program is recorded, characterized in that said program contains:
a reception step of receiving control data which are transferred from a controller by using a first transfer pattern conformed with a procedure determined on the basis of the specification of itself or by a second transfer pattern using commands defined between the controller and a reception side;
a judging step of judging whether the control data received in the processing of said reception step are transferred by using the first transfer pattern or the second transfer pattern;
a first executing step of interpreting the meaning of the procedure and executing the processing based on the interpretation result on signals transmitted through a transfer medium when it is judged in the processing of said judging step that the control data are transferred by using the first transfer pattern; and
a second executing step of interpreting the meaning of the procedure and executing the processing based on the interpretation result on signals transmitted through a transfer medium when it is judged in the processing of said judging means that the control data are transferred by using the second transfer pattern.
